(19) United States
(12) Patent Application Publication
(10) Pub. No.: US 2016/0099960 A1
(43) Pub. Date: Apr. 7, 2016

(54) System and method for scanning hosts using an autonomous, self-destructing payload

(71) Applicant: Infocyte, Inc., San Antonio, TX (US)

(72) Inventors: Christopher Gerritz, San Antonio, TX (US); Ryan Morris, San Antonio, TX (US)

(21) Appl. No.: 14/503,982

(22) Filed: Oct. 1, 2014

(51) Int. Cl. H04L 29/06

(52) U.S. Cl. CPC H04L 63/1425; H04L 63/145

(57) ABSTRACT

A method for scanning hosts using an autonomous, self-destructing payload, deploying, by a computing device, at least one payload to at least one host, the at least one payload comprising at least one instruction to scan the at least one host for malicious activity, an instruction to produce and store in the memory of the at least one host an encrypted output file, and an instruction to delete the payload. The method includes disconnecting, by the computing device, from the at least one host. The method includes executing, by the at least one host, the payload, while disconnected from the computing device. The method includes reconnecting, by the computing device, to the at least one host. The method includes retrieving, by the computing device, from the at least one host, the encrypted output file. The method includes analyzing, by the computing device, the encrypted output file for evidence of malicious activity.

### TECHNICAL FIELD

Embodiments disclosed herein relate generally to systems for detecting malicious activity on computer networks, and specifically to the detection and neutralization of intrusions and malware on host systems.

### BACKGROUND ART

Traditional network security generally works according to three phases known as preventing, detecting, and responding to intrusions on the network. Prevention, which is concerned with blocking infiltration attempts and installation of malware, is performed through vulnerability patching, anti-virus scanning of incoming files, IP/domain filtering, and network intrusion prevention systems (IPS). Detection, which concerns identifying existing malware infections and signs of security breaches, is typically conducted using various network and host-based sensors which are able to identify attacks based on previously seen characteristics (signatures) and behaviors (heuristics). Response, which deals with limiting the damage incurred by the protected host, has centered on post-mortem forensic investigations. Standard response when an intrusion does occur has been to characterize the attack via forensics, implement network blocks to prevent further activity, and reconstituting (wiping/reloading) the compromised systems.

Unfortunately, today's hackers remain more agile, flexible and devious than these processes, which often are expensive and lengthy. The situation is exacerbated by the continuing advancement and organization of these adversaries, which now includes organized cybercrime, state-sponsored spies, and corporate/industrial espionage. In particular hackers, and the programs they devise, have become increasingly skilled at detecting the form of protection a particular target is using, and acting to circumvent or disrupt that protection.

There is thus a need for a powerful and adaptable security system that is difficult for adversaries to detect or circumvent.

### SUMMARY OF THE EMBODIMENTS

A method is disclosed for scanning hosts using an autonomous, self-destructing payload. The method includes deploying, by a computing device, at least one payload to at least one host, the at least one payload having at least one instruction to scan the at least one host for malicious activity, an instruction to produce and store in the memory of the at least one host an encrypted output file, and an instruction to delete the payload. The method includes executing, by the at least one host, the payload, while disconnected from the computing device. The method includes retrieving, by the computing device, from the at least one host, the encrypted output file. The method includes analyzing, by the computing device, the encrypted output file for evidence of malicious activity.

In a related embodiment, deploying further involves receiving data concerning the at least one host and selecting, based on the data, at least one payload from a plurality of payloads. In another embodiment, executing further includes collecting at least one signature. In an additional embodiment, executing also includes collecting at least one potential malware file. In an additional embodiment, executing also involves collecting machine analytics. In still another embodiment, executing further includes evaluating at least one operating system kernel memory structure of the at least one host for indications of tampering. In yet another embodiment, evaluating further involves searching for a hook. In another embodiment still, evaluating also includes scanning for modifications to kernel protection features. In an additional embodiment, executing further involves evaluating an operating system boot-up sequence for signs of redirection of the boot process. In a further embodiment, executing also includes collection of a vendor digital certificate of at least one file.

In a still further embodiment, executing also involves scanning memory of the at least one host to identify insecure coding practices. In an additional embodiment, executing further involves scanning for remote accesses by users having administrative privileges. Executing further involves analyzing memory to detect process injections, in another embodiment. In a further embodiment, executing additionally involves determining that the at least one host is compromised and locking down the at least one host. In an additional embodiment, executing further involves determining that the at least one host is compromised an alerting at least one user regarding the determination. In still another embodiment, executing further includes deleting a detected threat. In yet another embodiment, executing also involves executing a sniffer on the at least one host.

In an additional embodiment, analyzing further includes analyzing the encrypted output file for evidence of tampering. In another embodiment, analyzing further involves querying a machine analytics database using machine analytics data contained in the encrypted output file. In still another embodiment, analyzing also involves querying a signature database using signature data contained in the encrypted output file. In a further embodiment, analyzing also includes performing sandbox testing of data identified by the encrypted output file. In a still further embodiment, analyzing additionally involves comparing the vendor digital certificate of at least one file with an associated and validly signed digital signature. In another embodiment, analyzing further includes aggregation of test results from multiple hosts to statistically identify deviations from norms. In yet another embodiment, analyzing further involves providing data from the encrypted output file to a user. Still another embodiment also involves scanning the at least one host file to verify deletion of the payload.

Also disclosed is a method for scanning host machines using an autonomous, self-destructing payload. The method includes receiving, by a host, at least one payload comprising at least one instruction to scan the host for malicious activity, an instruction to produce and store in the memory of the host an encrypted output file, and an instruction to delete the payload. The method includes scanning for malicious activity, by the host, based on the at least one instruction to scan the at least one host for malicious activity. The method includes producing and storing in memory an encrypted output file, by the host, based on the instruction to produce the encrypted output file. The method includes deleting, by the one host, the at least one payload.

Also disclosed is a system for scanning host machines using an autonomous, self-destructing payload. The system includes at least one host and a computing device, configured to connect to the at least one host, install at least one payload on the at least one host, the at least one payload comprising at least one instruction to scan the at least one host for malicious activity, an instruction to produce an encrypted output file, an instruction to store the encrypted output file in the memory of the at least one host machine, and an instruction to delete the payload, disconnect from the at least one host, reconnect to the at least one host, to retrieve, by the computing device, from the at least one host, the encrypted output file, and analyze, by the computing device, the encrypted output file for evidence of malicious activity.

Other aspects, embodiments and features of the system and method will become apparent from the following detailed description when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the system and method shown where illustration is not necessary to allow those of ordinary skill in the art to understand the system and method.

### BRIEF DESCRIPTION OF THE DRAWINGS

The preceding summary, as well as the following detailed description of the disclosed system and method, will be better understood when read in conjunction with the attached drawings. For the purpose of illustrating the system and method, presently preferred embodiments are shown in the drawings. It should be understood, however, that neither the system nor the method is limited to the precise arrangements and instrumentalities shown.

FIG. 1A is a schematic diagram depicting an example of an computing device as described herein;

FIG. 1B is a schematic diagram of a network-based platform, as disclosed herein;

FIG. 2 is a block diagram depicting one embodiment of the disclosed system; and

FIG. 3 is a flow chart illustrating one embodiment of the claimed method; and

FIG. 4 is a flow chart illustrating one embodiment of the claimed method.

### DETAILED DESCRIPTION OF SPECIFIC EMBODIMENTS

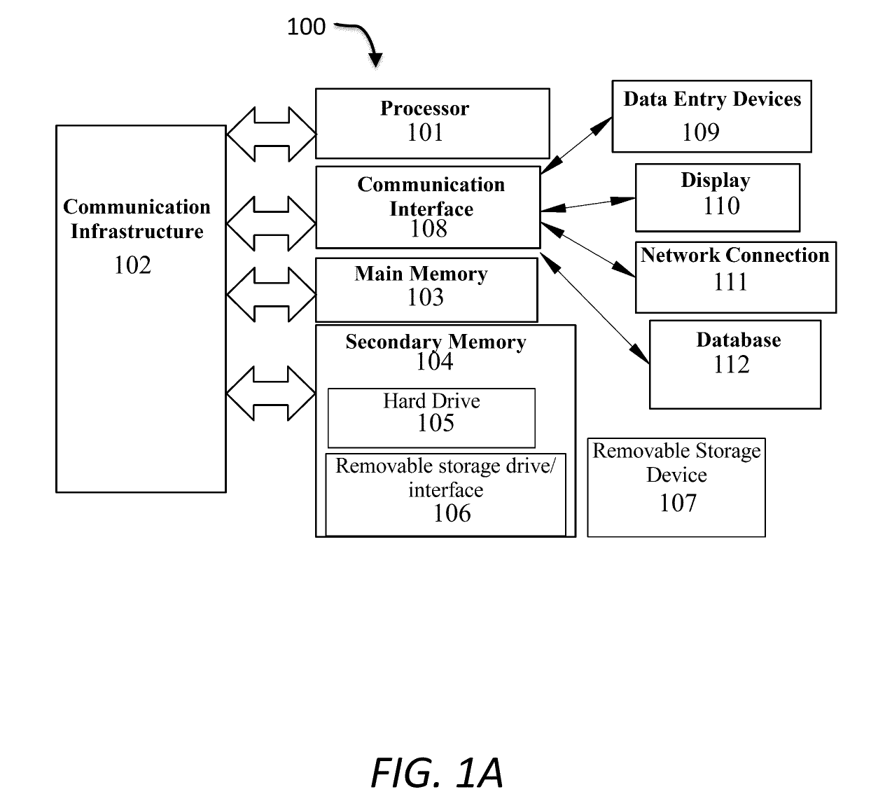

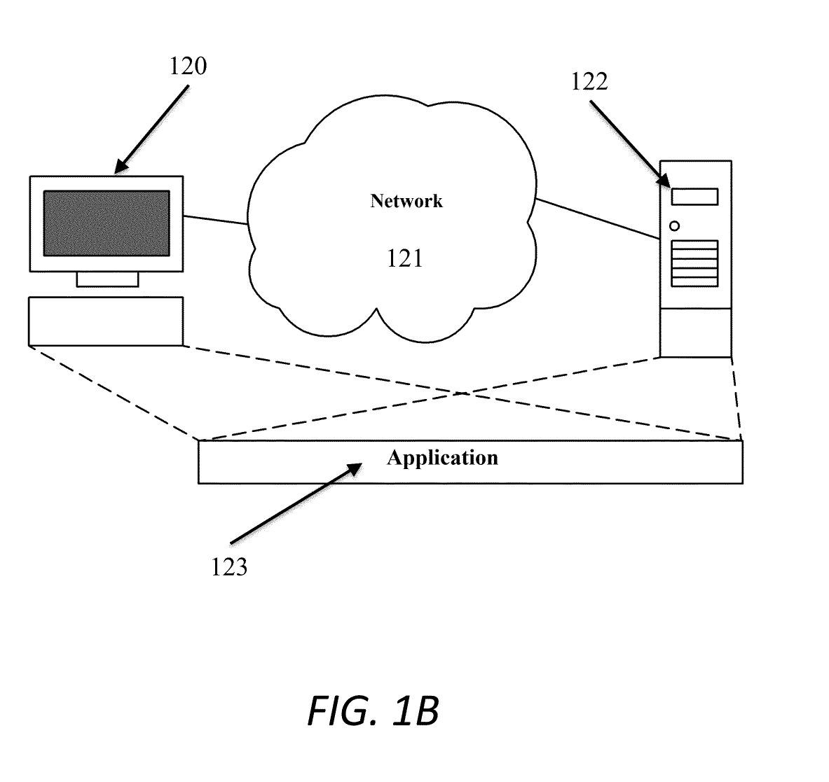

Some embodiments of the disclosed system and methods will be better understood by reference to the following comments concerning computing devices. A “computing device” may be defined as including personal computers, laptops, tablets, smart phones, and any other computing device capable of supporting an application as described herein. The system and method disclosed herein will be better understood in light of the following observations concerning the computing devices that support the disclosed application, and concerning the nature of web applications in general. An exemplary computing device is illustrated by FIG. 1A. The processor 101 may be a special purpose or a general-purpose processor device. As will be appreciated by persons skilled in the relevant art, the processor device 101 may also be a single processor in a multi-core/multiprocessor system, such system operating alone, or in a cluster of computing devices operating in a cluster or server farm. The processor 101 is connected to a communication infrastructure 102, for example, a bus, message queue, network, or multi-core message-passing scheme.

The computing device also includes a main memory 103, such as random access memory (RAM), and may also include a secondary memory 104. Secondary memory 104 may include, for example, a hard disk drive 105, a removable storage drive or interface 106, connected to a removable storage unit 107, or other similar means. As will be appreciated by persons skilled in the relevant art, a removable storage unit 107 includes a computer usable storage medium having stored therein computer software and/or data. Examples of additional means creating secondary memory 104 may include a program cartridge and cartridge interface (such as that found in video game devices), a removable memory chip (such as an EPROM, or PROM) and associated socket, and other removable storage units 107 and interfaces 106 which allow software and data to be transferred from the removable storage unit 107 to the computer system. In some embodiments, to “maintain” data in the memory of a computing device means to store that data in that memory in a form convenient for retrieval as required by the algorithm at issue, and to retrieve, update, or delete the data as needed.

The computing device may also include a communications interface 108. The communications interface 108 allows software and data to be transferred between the computing device and external devices. The communications interface 108 may include a modem, a network interface (such as an Ethernet card), a communications port, a PCMCIA slot and card, or other means to couple the computing device to external devices. Software and data transferred via the communications interface 108 may be in the form of signals, which may be electronic, electromagnetic, optical, or other signals capable of being received by the communications interface 108. These signals may be provided to the communications interface 108 via wire or cable, fiber optics, a phone line, a cellular phone link, and radio frequency link or other communications channels. Other devices may be coupled to the computing device 100 via the communications interface 108. In some embodiments, a device or component is “coupled” to a computing device 100 if it is so related to that device that the product or means and the device may be operated together as one machine. In particular, a piece of electronic equipment is coupled to a computing device if it is incorporated in the computing device (e.g. a built-in camera on a smart phone), attached to the device by wires capable of propagating signals between the equipment and the device (e.g. a mouse connected to a personal computer by means of a wire plugged into one of the computer's ports), tethered to the device by wireless technology that replaces the ability of wires to propagate signals (e.g. a wireless BLUETOOTH® headset for a mobile phone), or related to the computing device by shared membership in some network consisting of wireless and wired connections between multiple machines (e.g. a printer in an office that prints documents to computers belonging to that office, no matter where they are, so long as they and the printer can connect to the internet). A computing device 100 may be coupled to a second computing device (not shown); for instance, a server may be coupled to a client device, as described below in greater detail.

The communications interface in the system embodiments discussed herein facilitates the coupling of the computing device with data entry devices 109, the device's display 110, and network connections, whether wired or wireless 111. In some embodiments, “data entry devices” 109 are any equipment coupled to a computing device that may be used to enter data into that device. This definition includes, without limitation, keyboards, computer mice, touchscreens, digital cameras, digital video cameras, wireless antennas, Global Positioning System devices, audio input and output devices, gyroscopic orientation sensors, proximity sensors, compasses, scanners, specialized reading devices such as fingerprint or retinal scanners, and any hardware device capable of sensing electromagnetic radiation, electromagnetic fields, gravitational force, electromagnetic force, temperature, vibration, or pressure. A computing device's “manual data entry devices” is the set of all data entry devices coupled to the computing device that permit the user to enter data into the computing device using manual manipulation. Manual entry devices include without limitation keyboards, keypads, touchscreens, track-pads, computer mice, buttons, and other similar components. A computing device may also possess a navigation facility. The computing device's “navigation facility” may be any facility coupled to the computing device that enables the device accurately to calculate the device's location on the surface of the Earth. Navigation facilities can include a receiver configured to communicate with the Global Positioning System or with similar satellite networks, as well as any other system that mobile phones or other devices use to ascertain their location, for example by communicating with cell towers. A code scanner coupled to a computing device is a device that can extract information from a “code” attached to an object. In one embodiment, a code contains data concerning the object to which it is attached that may be extracted automatically by a scanner; for instance, a code may be a bar code whose data may be extracted using a laser scanner. A code may include a quick-read (QR) code whose data may be extracted by a digital scanner or camera. A code may include a radio frequency identification (RFID) tag.

In some embodiments, a computing device's “display” 109 is a device coupled to the computing device, by means of which the computing device can display images. Display include without limitation monitors, screens, television devices, and projectors.

Computer programs (also called computer control logic) are stored in main memory 103 and/or secondary memory 104. Computer programs may also be received via the communications interface 108. Such computer programs, when executed, enable the processor device 101 to implement the system embodiments discussed below. Accordingly, such computer programs represent controllers of the system. Where embodiments are implemented using software, the software may be stored in a computer program product and loaded into the computing device using a removable storage drive or interface 106, a hard disk drive 105, or a communications interface 108.

The computing device may also store data in database 112 accessible to the device. A database 112 is any structured collection of data. As used herein, databases can include “NoSQL” data stores, which store data in a few key-value structures such as arrays for rapid retrieval using a known set of keys (e.g. array indices). Another possibility is a relational database, which can divide the data stored into fields representing useful categories of data. As a result, a stored data record can be quickly retrieved using any known portion of the data that has been stored in that record by searching within that known datum's category within the database 112, and can be accessed by more complex queries, using languages such as Structured Query Language, which retrieve data based on limiting values passed as parameters and relationships between the data being retrieved. More specialized queries, such as image matching queries, may also be used to search some databases. A database can be created in any digital memory.

Persons skilled in the relevant art will also be aware that while any computing device must necessarily include facilities to perform the functions of a processor 101, a communication infrastructure 102, at least a main memory 103, and usually a communications interface 108, not all devices will necessarily house these facilities separately. For instance, in some forms of computing devices as defined above, processing 101 and memory 103 could be distributed through the same hardware device, as in a neural net, and thus the communications infrastructure 102 could be a property of the configuration of that particular hardware device. Many devices do practice a physical division of tasks as set forth above, however, and practitioners skilled in the art will understand the conceptual separation of tasks as applicable even where physical components are merged.

The systems may be deployed in a number of ways, including on a stand-alone computing device, a set of computing devices working together in a network, or a web application. Persons of ordinary skill in the art will recognize a web application as a particular kind of computer program system designed to function across a network, such as the Internet. A schematic illustration of a web application platform is provided in FIG. 1A. Web application platforms typically include at least one client device 120, which is an computing device as described above. The client device 120 connects via some form of network connection to a network 121, such as the Internet. The network 121 may be any arrangement that links together computing devices 120, 122, and includes without limitation local and international wired networks including telephone, cable, and fiber-optic networks, wireless networks that exchange information using signals of electromagnetic radiation, including cellular communication and data networks, and any combination of those wired and wireless networks. Also connected to the network 121 is at least one server 122, which is also an computing device as described above, or a set of computing devices that communicate with each other and work in concert by local or network connections. Of course, practitioners of ordinary skill in the relevant art will recognize that a web application can, and typically does, run on several servers 122 and a vast and continuously changing population of client devices 120. Computer programs on both the client device 120 and the server 122 configure both devices to perform the functions required of the web application 123. Web applications 123 can be designed so that the bulk of their processing tasks are accomplished by the server 122, as configured to perform those tasks by its web application program, or alternatively by the client device 120. Some web applications 123 are designed so that the client device 120 solely displays content that is sent to it by the server 122, and the server 122 performs all of the processing, business logic, and data storage tasks. Such “thin client” web applications are sometimes referred to as “cloud” applications, because essentially all computing tasks are performed by a set of servers 122 and data centers visible to the client only as a single opaque entity, often represented on diagrams as a cloud.

Many computing devices, as defined herein, come equipped with a specialized program, known as a web browser, which enables them to act as a client device 120 at least for the purposes of receiving and displaying data output by the server 122 without any additional programming. Web browsers can also act as a platform to run so much of a web application as is being performed by the client device 120, and it is a common practice to write the portion of a web application calculated to run on the client device 120 to be operated entirely by a web browser. Such browser-executed programs are referred to herein as “client-side programs,” and frequently are loaded onto the browser from the server 122 at the same time as the other content the server 122 sends to the browser. However, it is also possible to write programs that do not run on web browsers but still cause an computing device to operate as a web application client 120. Thus, as a general matter, web applications 123 require some computer program configuration of both the client device (or devices) 120 and the server 122. The computer program that comprises the web application component on either computing device's system FIG. 1A configures that device's processor 200 to perform the portion of the overall web application's functions that the programmer chooses to assign to that device. Persons of ordinary skill in the art will appreciate that the programming tasks assigned to one device may overlap with those assigned to another, in the interests of robustness, flexibility, or performance. Furthermore, although the best known example of a web application as used herein uses the kind of hypertext markup language protocol popularized by the World Wide Web, practitioners of ordinary skill in the art will be aware of other network communication protocols, such as File Transfer Protocol, that also support web applications as defined herein.

Embodiments of the disclosed methods and system detect and neutralize malicious activity on host machines and networks by deploying self-destructing autonomous payloads that can execute while disconnected from the server that deployed them. The self-destruction of the payloads ensures that malefactors will not be able to analyze the detection methods of the payloads and evade them. The payloads may be custom-designed to ignore known features of a host and to collect unknown features whose safety is unclear for further analysis.

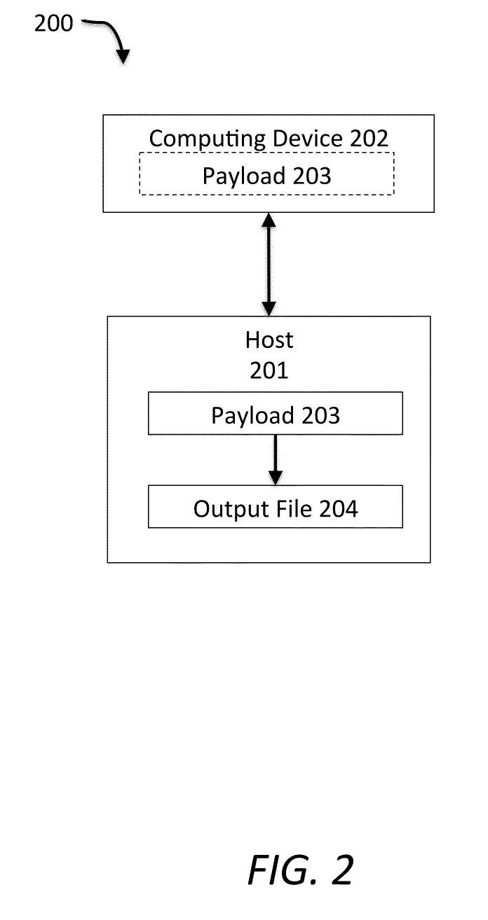

FIG. 2 illustrates some embodiments of the disclosed system 200. The system 200 includes at least one host 201. In some embodiments, the at least one host 201 is a computing device 100 as disclosed above in reference to FIGS. 1A-1B. In some embodiments, the at least one host 201 is a set of computing devices 100 as disclosed above in reference to FIGS. 1A-1B, working in concert; the computing devices may be connected by a network 121 as disclosed above in reference to FIGS. 1A-1B. For example, the at least one host 201 may be the computer system of a company, including various personal computers, servers, databases, firewalls, printers, routers, and other information technology devices and infrastructure.

The system includes a computing device 202. In some embodiments, the computing device 202 is a server 122 as described above in reference to FIGS. 1A-1B. The computing device 202 may also be local device, such as a work-station or other computing device capable of communicating with the host 201. In some embodiments, the computing device 202 is configured to connect to the at least one host and install at least one payload 203 on the at least one host 201. The computing device 202 may connect to the at least one host 201 via a network 121 as disclosed above. The computing device 202 may be configured to retrieve an output file 204 produced by the at least one payload 203. In some embodiments, a payload 203 is a set of instructions deployed to the at least one host 201, which are executed on the at least one host 201, as set forth in further detail below. The at least one payload 201 may function as a computer program, as described above in reference to FIGS. 1A-1B, installed on the at least one host 201. The at least one payload may function as configuration instructions for computer programs installed on the at least one host 201. The computing device 202 may include at least one specialized machine or set of machines; for instance, the computing device 202 may include a dedicated set of machines in which it deploys a sandbox environment for sandbox testing as described in further detail below.

Some embodiments of the system 200 methods involve the use of cryptographic systems. In one embodiment, a cryptographic system is a system that converts data from a first form, known as “plaintext,” which may be intelligible when viewed in its intended format, into a second form, known as “cyphertext,” which may not be intelligible when viewed in the same way. The cyphertext is may be unintelligible in any format unless first converted back to plaintext. In one embodiment, the process of converting plaintext into cyphertext is known as “encryption.” The encryption process may involve the use of a datum, known as an “encryption key,” to alter the plaintext. The cryptographic system may also convert cyphertext back into plaintext, which is a process known as “decryption.” The decryption process may involve the use of a datum, known as a “decryption key,” to return the cyphertext to its original plaintext form. In embodiments of cryptographic systems that are “symmetric,” the decryption key is essentially the same as the encryption key: possession of either key makes it possible to deduce the other key quickly without further secret knowledge. The encryption and decryption keys in symmetric cryptographic systems may be kept secret, and shared only with persons or entities that the user of the cryptographic system wishes to be able to decrypt the cyphertext. One example of a symmetric cryptographic system is the Advanced Encryption Standard (“AES”), which arranges plaintext into matrices and then modifies the matrices through repeated permutations and arithmetic operations using an encryption key. In embodiments of cryptographic systems that are “asymmetric,” either the encryption or decryption key cannot be readily deduced without additional secret knowledge, even given the possession of the corresponding decryption or encryption key, respectively; a common example is a “public key cryptographic system,” in which possession of the encryption key does not make it practically feasible to deduce the decryption key, so that the encryption key may safely be made available to the public. An example of a public key cryptographic system is RSA, in which the encryption key involves the use of numbers that are products of very large prime numbers, but the decryption key involves the use of those very large prime numbers, such that deducing the decryption key from the encryption key requires the practically infeasible task of computing the prime factors of a number which is the product of two very large prime numbers.

In some embodiments, the cryptographic system is designed so that it is either very difficult or impossible to decrypt the cyphertext without the decryption key. In computationally secure cryptographic systems, decrypting the cyphertext requires a computing device attempting decryption without the decryption key to perform a sufficiently large number of steps that any currently available computing device would be unable to complete such a decryption in any practically useful amount of time; for instance, breaking a single instance of a computationally secure cyphertext with the best available computers might take several years. In information-theoretically secure cryptographic systems, decrypting the cyphertext without the decryption key is impossible even given unlimited computing power, provided certain assumptions concerning the circumstances of the cryptographic system's use are met. Computationally secure cryptographic systems may become insecure either because somebody discovers a way to decrypt cyphertext without an encryption key in fewer computing steps, known as “breaking” the cryptographic system, or because computing devices develop to the point where decryption without a decryption key and without breaking the cryptographic system, which is known as the “brute force” approach, becomes practically feasible. An information-theoretically secure cryptographic system cannot become insecure unless somebody breaks it. A particular implementation of a cryptographic system may also be broken because that the way in which that implementation was designed failed to accomplish the degree of security theoretically possible for the cryptographic system. The cryptographic system may be broken for all implementations, which involve discovering a flaw in the theoretical degree of security in the cryptographic system.

Some embodiments of the disclosed system involve the use of digital signatures. In one embodiment, a digital signature is an encrypted a mathematical representation of a file using the private key of a public key cryptographic system. The signature may be verified by decrypting the encrypted mathematical representation using the corresponding public key and comparing the decrypted representation to a purported match that was not encrypted; if the signature protocol is well-designed and implemented correctly, this means the ability to create the digital signature is equivalent to possession of the private decryption key. Likewise, if the mathematical representation of the file is well-designed and implemented correctly, any alteration of the file will result in a mismatch with the digital signature; the mathematical representation may be produced using an alteration-sensitive, reliably reproducible algorithm, such as a hashing algorithm. A mathematical representation to which the signature may be compared may be included with the signature, for verification purposes; in other embodiments, the algorithm used to produce the mathematical representation is publically available, permitting the easy reproduction of the mathematical representation corresponding to any file. In some embodiments, a third party known as a certificate authority is available to verify that the possessor of the private key is a particular entity; thus, if the certificate authority may be trusted, and the private key has not been stolen, the ability of a entity to produce a digital signature confirms the identity of the entity, and links the file to the entity in a verifiable way. In other embodiments, the digital signature is verified by comparing the digital signature to one known to have been created by the entity that purportedly signed the digital signature; for instance, if the public key that decrypts the known signature also decrypts the digital signature, the digital signature may be considered verified. The digital signature may also be used to verify that the file has not been altered since the formation of the digital signature.

Some embodiments of the system 200 and method involve the use of virtual environments. In some embodiments, virtual environments are environments in which one or more software elements, known as hypervisors, imitate the behavior of elements of hardware, so that a computer program designed to interact with the elements of hardware can interact with the hypervisors instead of the hardware. In some embodiments, the computer program can interact with the hypervisors with no modification to the computer program. In some embodiments, the computer program does not have any way to detect that it is interacting with a hypervisor, rather than with the hardware element the hypervisor imitates. The virtual environment may be a virtual machine, which imitates the behavior of all or substantially all of the hardware on a computing device 100 as described above in reference to FIGS. 1A-1B.

Some embodiments of the system 200 and methods described herein concern the detection and elimination of malicious software, otherwise known as “malware.” In one embodiment, malware is software that executes on the at least one host 201 to perform actions not intended by the proprietor of the at least one host 201. Malware may install itself on the at least one host 201 against the will of the proprietor; the installation may be effected secretly by a “worm,” which installs itself via a security vulnerability on the at least one host. The installation may involve tricking a user of the at least one host 201 into installing the malware; for instance, a “Trojan” may convince the user to execute a program masquerading as a legitimate program, causing the malware to install upon execution. The installation may be performed by locally by a user, such as a user that, either intentionally or unwittingly, connects a memory device or computing device containing the malware to the at least one host 201. An insider, such as a spy, a disgruntled employee, or a blackmailed employee, may intentionally disable the existing protection mechanisms in place on the at least one host 201; the insider may install malware on the host 201.

The malware may use privilege escalation to gain a great degree of access to the at least one host 201. In one embodiment, privilege escalation is a process whereby a user or an application such as malware that has one set of access rights within the at least one host 201 gains additional access rights within the at least one host 201. In one embodiment, privilege escalation includes vertical privilege escalation, in which the user or application gains a higher degree of access to the host 201 than the initial access rights allowed; for instance, the user or application may initially have ordinary “user” privileges that do not permit the user or application to modify an operating system kernel of a computing device included on the at least one host 201, and may gain administrative or “root” privileges that enable the user or application to modify the kernel. In other embodiments, privilege escalation includes horizontal privilege escalation, in which the user or application gains the right of access to a user account or file to which the user or application originally was forbidden to access. The user or application may perform achieve privilege escalation by exploiting a bug or design flaw in privilege control mechanisms on the at least one host 201.

The malware may perform any number of malicious activities on the at least one host 201, singly or together. The malware may be a “virus” that causes the at least one host 201 to create new copies of the malware and insert them into various files. The malware 201 may be a “key logger,” which records data entered by a user via data entry devices 109, such as keyboards or touchscreens. The malware may extract data from files on the at least one host 201. In some embodiments, the malware transmits data obtained by its processes to other computing devices; the malware may, for instance, convey financial or other information used in identity theft to a device operated by a criminal, so that the criminal can use that information to make money, by identity theft or blackmail. The malware may download data and store it on the at least one host 201 to use against a user later for financial gain, in a badger game or similar scheme. The malware may store information on a removable memory device, which is later recovered by a criminal who has physical access to the at least one host 201. In other embodiments, the malware performs actions that interfere with the functioning of the at least one host 201 as configured on behalf of its users. For instance, the malware may create a new security vulnerability or “back door” so that a malefactor can gain access to the at least one host 201 for further intrusions as described below. The malware may cause one or more applications on the at least one host 201 to stop working correctly. The malware may overwrite or delete data on the at least one host 201. The malware may encrypt data on the at least one host 201 or otherwise render it inaccessible to users; a criminal using the malware may demand payment in exchange for releasing the data. The malware may render software on the at least one host 201 inoperable. The malware may damage host hardware 201, for instance by switching off cooling fans or “overclocking” hardware elements to cause them to overheat and destroy themselves. The malware may cause machinery controlled by the at least one host 201 or by a device connected to the at least one host 201 to malfunction, causing destruction, injury, or death.

The malware may include one or more elements that enable the malware to escape detection by processes running on the at least one host 201. For instance the malware may include one or more “rootkits.” In one embodiment, a rootkit is a computer program, as defined above in reference to FIGS. 1A-1B, which acts to hide certain computer programs or computer processes from users or other processes. It may do so by installing dynamically linked library files that allow the insertion of a concealed process into other processes via the dynamic linking methodology of an operating system, or by inserting new links into such files, in a process sometimes referred to as “DLL injection.” The rootkit may also conceal processes by overwriting the memory of a target application. The rootkit may conceal processes by replacing components of the core operating system or kernel. The rootkit may function by inserting a “hypervisor” that moves the operating system onto a virtual machine, seizing control with all hardware interfaces as a result. The rootkit may also conceal processes by means of compromised firmware. The rootkit may also conceal processes by means of compromised hardware; for instance, the hardware may be configured during manufacture to contain concealed malware or a means to conceal malware. The rootkit may use hardware injection to conceal processes and install itself. The rootkit may be embodied in a device driver, which may masquerade as a legitimate device, such as a USB controller. As a non-limiting example, rootkit modified hardware may be contained in a device that can be incorporated in a computing device 100 as disclosed above in reference to FIGS. 1A-1B, such as the processor 101, communication infrastructure 102, communication interface 108, main memory 103, or secondary memory 104; for instance, the rootkit may be concealed in a USB memory device attached to the computing device. The rootkit may be concealed in any peripheral hardware or software coupled to a computing device 100, including data entry devices 109, or network connection facilities, printers, routers, and modems.

A rootkits may use one or more “hooks” to achieve insertion in processes and to evade detection. In an embodiment, a hook is an element of a computer program that intercepts function calls, events, messages, or other data being passed within or between software components. For instance, a hook may permit a rootkit to insert itself or other malware into a process by intercepting a function or application programming interface (API) call, and using code from the rootkit or malware to perform the function; the code that receives the call may evade detection by apparently performing the function as originally designed, while also performing other steps as desired by the designer of the rootkit or malware. The hook may return filtered data with the incriminating information removed before presentation to the user. Hooks may be inserted into import tables or dynamically linked library files during execution of code. The ways in which rootkits act to redirect and manipulate processes on a host 201, including hooking operating system APIs to hide files, processes, and indications of malware presence, may be referred to as “rootkit subversion techniques.”

In some embodiments, the system 200 uses signatures to detect malware. In one embodiment, a signature is a pattern, in any kind of computer program as described above in reference to FIGS. 1A-1B, that is known to be associated with a particular program, application, or item of malware. For instance, a malware product may rely for its core function on the use of a particular algorithm that produces a particular hexadecimal or binary sequence in machine code; the malware product may be able to modify its name and some of its functions during replication or in various generations, but if the signature is chosen effectively, the malware may not be able to continue to function as designed if it modifies its signature. In some embodiments, the use of signatures requires analysis of known computer programs, such as known malware files; as a result, signature detection techniques may lag behind the production of novel forms of malware, particularly when the novel forms succeed in evading detection for an extended period of time, for instance when the malware does not begin malicious activity until a certain calendar date. The use of signatures may be enhanced in some embodiments by heuristic approaches, such as comparison of scanned code to patterns likely to be associated with particular approaches to malware algorithms, or patterns likely to be used to exploit particular known security vulnerabilities. In some embodiments, the system 200 avoids mistaking non-malicious code that matches a heuristic test for malware by use of analysis on the computing device 202, sandbox testing, or analysis by a user, as set forth in further detail below.

The computing device 202 may test potential malware in a sandbox. In one embodiment, a sandbox is an environment in which a computer program can be executed essentially without affecting any other environments, and generally without permanently affecting the sandbox itself. A sandbox may be run on a dedicated computing device. The sandbox may be run in “scratch space” or other space that may be tightly controlled. In some embodiments, the sandbox is a virtual environment, such as a virtual machine, which is capable of intercepting virtually any attempt by a computer program executed in the sandbox to access hardware directly. The sandbox environment may use hypervisors that analyze the attempts of a potentially malicious program to interact with its apparent hardware environment. In some embodiments, the sandbox is also analyzed by a user, such as a security expert. The sandbox may be isolated from the rest of the computing device 202 while it is executing; for instance, the sandbox may be physically disconnected from any network to which the computing device 202 is connected; the sandbox may have any hardware that a malicious program could use to connect to the network, such as wi-fi communication modems, disabled or removed. The sandbox may be configured with a baseline environment representing an unmodified system, or can be configured to match the desired environment of the host. In some embodiments, the sandbox is reset after each use; the reset may be a hard reset in which all software is removed, the memory of the sandbox environment or the machine or machines on which it is run is overwritten, and the sandbox environment is subsequently reinstalled. The hard reset may include analysis of firmware on machines running the sandbox environment to ensure there has been no corruption of any hardware elements, such as BIOS chips, requiring the replacement of those hardware elements. One example of a commercially available sandbox environment is the CUCKOO sandbox environment developed by the Cuckoo Foundation of Stichting, Netherlands. Another example is the FIREEYE sandbox environment produced by FireEye, Inc. of Milpitas, Calif.

In some embodiments, the system 200 is configured to detect intrusions. In one embodiment, an intrusion is a breach in security on a host 201 whereby a person, group of persons, or remote machine gains unauthorized access to the at least one host 201. In some embodiments, the perpetrator of an intrusion gains access to the at least one host 201 via social engineering. For instance, the perpetrator may steal login information from an authorized user. The perpetrator may purchase login information from an authorized user. The perpetrator may trick an authorized user into giving the perpetrator login information; as a non-limiting example, the perpetrator may convince a system administrator that the perpetrator is an authorized user who has lost his or her login information, perhaps using personal information stolen from the spoofed authorized user. The perpetrator may be a formerly authorized user who continues to possess valid login information, such as a contractor whose contract has ended and whose login credentials were not canceled.

In other embodiments, the perpetrator may cause the breach by exploiting a flaw in the security protecting the at least one host 201; the flaw may be an error in the design or implementation of a security protocol in use on the at least one host 201. The flaw may be an intentionally inserted “back door” that permits people aware of it to bypass typically required security. In some instances, the back door may be a security work-around installed by developers implementing the security protocol, and left active accidentally or due to indifference on the part of the developers. In other embodiments, the perpetrator gains access via the installation of malware; for instance, the perpetrator may use a Trojan or worm that grants the perpetrator access to the at least one host 201. The malware may convey login information to the perpetrator, for instance using a key logger to record a user's login credentials when keyed in.

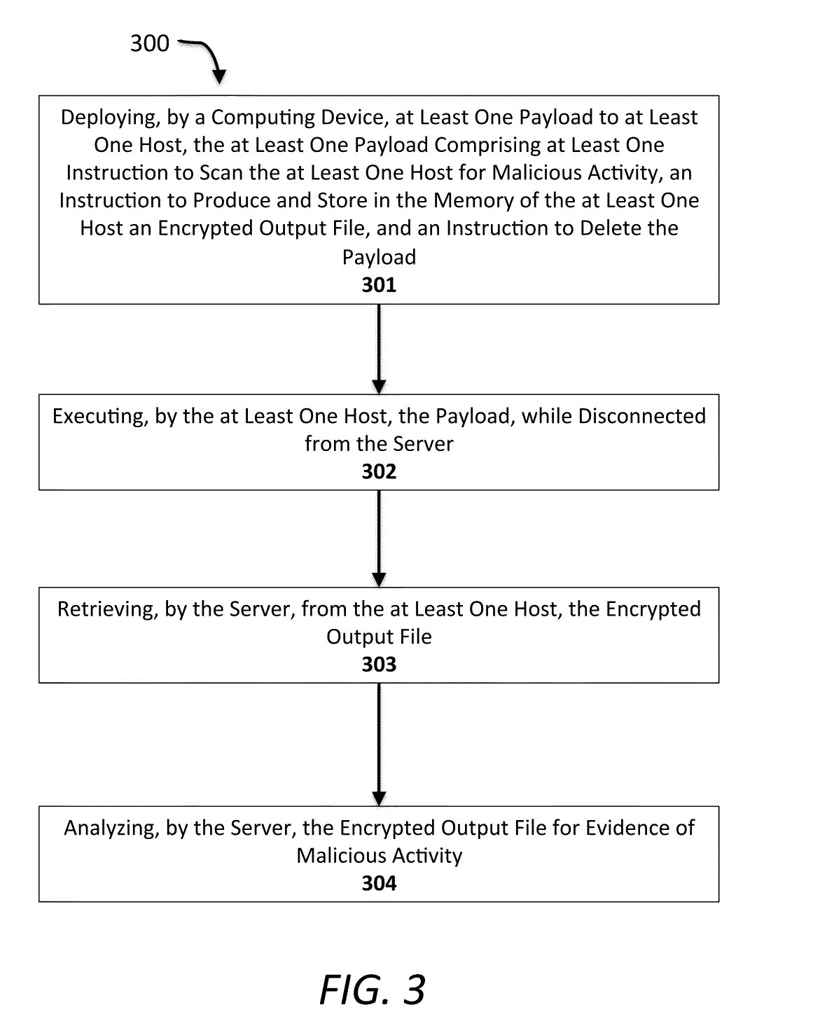

FIG. 3 illustrates some embodiments of a method 300 for scanning hosts using an autonomous, self-destructing payload. The method 300 includes deploying, by the computing device, at least one payload to the at least one host, the at least one payload comprising at least one instruction to scan the at least one host for malicious activity, an instruction to produce and store in the memory of the at least one host an encrypted output file, and an instruction to delete the at least one payload (301). The method 300 includes executing, by the at least one host, the at least one payload, while disconnected from the computing device (303). The method 300 includes retrieving, by the computing device, from the at least one host, the encrypted output file (304). The method 300 includes analyzing, by the computing device, the encrypted output file for evidence of malicious activity (305).

Referring to FIG. 3 in greater detail, and by reference to FIG. 2, the computing device 202 connects deploys a payload to at least one host. In some embodiments, the computing device 202 connects to the at least one host 201 via a network, as disclosed above in reference to FIGS. 1A-1B. In some embodiments, the computing device 202 connects using a secure connection protocol, such as hypertext transfer protocol secure (HTTPS); the computing device 202 may connect via a virtual private network (VPN). The computing device 202 may connect by means of a secure sockets connection. In other embodiments, the computing device 202 connects via an unsecured connection, such as a hypertext transfer protocol (HTTP) connection, or an unsecured sockets connection. The computing device 202 may connect via a remote access protocol; for instance, the computing device 202 may gain remote control over one or more computing devices making up the at least one host 201. The computing device 202 may gain the ability to control a machine incorporated in the at least one host 201 at one or more layers. For instance, the computing device 202 may gain administrative or “root” access to one or more computing devices making up the at least one host 202, and thus may have an unrestricted right to install or remove applications. As an example, the computing device 202 may have the ability to access and modify the operating system layer of a machine incorporated in the at least one host 202. The computing device 202 may be able to access protocols governing the interaction of the operating system with the hardware of a computing device incorporated in the at least one host 202; the computing device 202 may be able to access and manipulate a boot-loader on a computing device incorporated in the at least one host 202. The computing device 202 may be able to access and manipulate device drivers. The computing device 202 may be able to access and manipulate firmware. The computing device 202 may be able to install one or more hypervisors to act as intermediaries between the operating system and the hardware of one or more computing devices in the at least one host 201; for instance, the payload 203 installed as described in further detail below may introduce a virtualizing layer beneath the kernel, to aid in rootkit detection.

In some embodiments, firewalls protecting the at least one host 201 are configured to allow traffic from the computing device 201 to pass. In some embodiments, a terminal computing device is installed on the at least one host 201 to communicate with the computing device 202. The terminal computing device may establish a VPN connection with the computing device 202. The computing device 202 and operators of the computing device 202 may be granted administrative or root access to demilitarized zones (DMZ) and non-domain systems. In one embodiment, DMZs contain border systems that serve customers external to the network, such as public web services. In one embodiment, non-domain assets are not connected to the domain and usually require local accounts to authenticate. Performing assessments in the DMZ and on non-domain assets may be unique to each specific network and its particular technical and policy constraints. In some embodiments, the computing device 202 or an operator of the computing device 202 may receive network maps and description of how the at least one host 201 is remotely administered, such as via secure shell (SSH), or remote desktop protocol (RDP).

The computing device 202 and operators of the computing device 202 may gain the ability to perform remote execution of scripts and custom executables. The remote execution may be performed using one of many options available to operators to perform remote execution, each requiring different ports and protocols, including without limitation WINDOWS MANAGEMENT INSTRUMENTATION, Schtasks.exe, PSExec, and PSRemoting, produced by Microsoft Corporation, of Redmond, Wash. Where the at least one host 201 is running a Linux or Unix operating system, the computing device 202 may connect to the at least one host 201 via any suitable technique, including SSH or remote shell (RSH). The remote authentication method used may allow the computing device 202 or operators of the computing device 202 to perform administrative tasks on the remote computer without storing the administrator account password hash, Kerberos ticket granting tickets (TGTs), or other reusable credentials on the remote computer's memory. Therefore, using only management tools with these authentication mechanisms may reduce the risk of “pass the hash” and credential stealing attacks.

In some embodiments, the computing device 202 deploys the at least one payload 203 via a third party that has the capability to interact with the at least one host 201. As a non-limiting example, the at least one payload 203 may be deployed via the ENCASE ENTERPRISE, produced by Guidance Software, Inc. of Pasadena, Calif., the CHEF platform produced by Chef Software, Inc. of Seattle, Wash., or products of Puppet Labs, of Portland Oreg. For instance, the ENCASE platform might install the at least one payload 203 using one or more “EnScripts” associated with that platform.

In some embodiments, computing device 202 deploys the at least one payload 203 to the at least one host 201 by transmitting the at least one payload 203 to the at least one host 201 after connecting to the at least one host 201. In other embodiments, the computing device 202 deploys the at least one payload 203 via an intermediary; the at least one computing device 202 may transmit the at least one payload 203 to another computing device (not shown) that in turn transmits the at least one payload 203 to the at least one host 201. The at least one computing device 201 may insert the at least one payload 203 in another device having memory, such as a portable computing device, a portable memory device, or a disk, so that a user, such as an administrator, can locally install the at least one payload 203 on the at least one host 201. In some embodiment, the at least one payload 203 includes at least one instruction to scan the at least one host 201 for malware. In some embodiments, the at least one payload 203 includes an instruction to produce and store in the memory of the at least one host 201 an encrypted output file. In some embodiments, the at least one payload 203 includes an instruction to delete the at least one payload 203.

In some embodiments, the computing device 202 receives data concerning the at least one host 201 and selects the at least one payload 203 from a plurality of payloads, based on the data. In one embodiment, the data includes data concerning the configuration of the at least one host 201. Data concerning the configuration of the at least one host 201 may include how many computing devices the at least one host 201 includes. Data concerning the configuration of the at least one host 201 may include information concerning the nature of the network joining elements of the at least one host 201, such as the networking protocol used or the kinds of routers in use. Administrators of the at least one host 201 may provide the computing device 202 or the operator of the computing device with network maps and description of environment and any non-standard policies. The data concerning the configuration of the at least one host 201 may include one or more operating systems being run on the at least one host 201. The data may indicate which operating systems are virtual. The data concerning the configuration of the at least one host 201 may include the version of one or more operating systems running on the at least one host 201. The data concerning the configuration of the at least one host 201 may include the type, licensing information, or version of one or more applications running on the at least one host 201. The data concerning the configuration of the at least one host 201 may describe one or more hardware elements, such as particular microchips or processors, graphics cards, or other elements making up computing devices incorporated in the at least one host 201. The hardware information may include other devices such as printers, scanners, modems, or machinery controlled by the computing devices or containing special-purpose computing devices such as microcontrollers. In some embodiments, a user of the computing device 202 may assess information concerning the at least one host 201 to design a custom scanning strategy to be deployed by the at least one payload 203. The user and computing device 202 may identify components typically associated with underlying operating systems of the at least one host 201 and with the network environment being assessed. The computing device 202 may also acquire a baseline state for one or more hardware or software components of the at least one host 201 in a previous scan performed as described in reference to FIG. 3. The at least one payload 203 may then be designed to filter out known good indicators in order to target the scan to the “unknowns” in the environment of the at least one host 201, as set forth in further detail below.

In some embodiments, the computing device 202 selects the at least one payload 203 as guided by malicious logic reports and historical technical reports for a particular adversary, allowing the operator of the computing device 202 to tailor detection strategies and capabilities for a targeted adversary's specific tactics, techniques, and procedures. The selection of the at least one payload 203 may be further aided by first checking information related to previous attacks. As advanced threats are very persistent, malefactors may try again when their first attempts fail. This means a review of any previous unsuccessful attempts along with declared incidents may be fruitful.

In other embodiments, the computing device 202 or an operator of the computing device 202 coordinates with sensor analysts and reviews detected activity for patterns. Currently in many malware-detection systems, while high confidence alerts are given immediate response and investigation, many low confidence alerts end up getting ignored due to the volume of the alerts and the limited investigation capacity of most systems. In some embodiments, since advanced adversaries will attempt to blend into the noise of normal traffic, low confidence alerts are used to guide the prioritization of host surveys. The computing device 202 an operator of the computing device 202 may identify one or more trends or anomalies in the low confidence alert traffic to determine how best to select the priorities of the at least one payload 203. In still other embodiments, the computing device 202 or an operator of the computing device 202 uses critical asset lists to aid in the selection of the at least one payload 203. Critical asset lists may provide for prioritization of scans based on two factors: criticality of function the nodes are associated with, and the attacker's likelihood of attack of a specific asset; the critical asset list may describe centers of gravity, which are things like domain controllers, which either serve as high value targets or choke points that an active attacker will likely be vectored to in the course of an attack. The computing device 202 or an operator thereof may perform an assessment of vulnerabilities on the network, as assets with exploitable vulnerabilities are the most likely to be compromised.

The data may include the kind of scan the proprietor of the at least one host 201 has requested. Payloads 203 may be configured to include any scanning algorithm, as described in further detail below, depending on the needs, budget, and desire of a client. Payloads 203 may be selected according to a progression; for example, an initial scan may be faster and less invasive, and deployed on more elements of the at least one host 201, while subsequent scans may be deeper and more invasive to deal with particular host 201 elements that the initial scan indicates may need closer attention. The following table summarizes some exemplary scan options, although persons skilled in the art will be aware that many other options are possible, as informed by the disclosure:

| | | |
|---|---|---|
| Enterprise- | 50k+ hosts | Desire absolute minimum host intensity and |
| scope | | network I/O effects |
| Wide-scope | <50k hosts | Desire minimal host intensity and network |
| | | I/O effects |
| Base-scope | <5000 | Desire limited host intensity and network |
| | | I/O effects |
| Medium- | <500 hosts | Allow some host intensity and network I/O |
| scope | | effects |
| Tight-Scope | <50 hosts | Allow Intense host intensity and short |
| | | network I/O effects |
| Interactive | Single Host | No limits depending on user logon status |

The data may include the kind of scan necessitated by the current status of the at least one host 201; for instance, if the at least one host has exhibited symptoms consistent with a particular form of malicious activity, such as a known piece of malware, the at least one payload may contain instructions to aid in finding and neutralizing that form of malicious activity. A previous payload deployed by the system 201 may have detected one or more signs that a particular form of malicious activity has occurred or is occurring on the at least one host 201. The at least one payload 203 may search for a category of malicious activity for which the previous payload was not designed to search; for instance, a high-level scan might not search for rootkits, because searching for rootkits may be invasive and resource-intensive. In some embodiments, the computing device 202 selects the at least one payload 203 to perform a wide-scope scans that is extremely rapid but forgoes mathematical certainty for increased speeds by using custom search heuristics against a targeted subset of data collected from the at least one host 201. For example, the computing device 202 may perform a statistical examination of all running processes on the at least one host 201. Any system that draws suspicion in a wide-scope scan may then be selected for deeper system examination. The computing device may select a payload 203 as directed by a wide-scope scan to perform a more closely targeted deep inspection of the portion of the at least one host 201 suspected to be compromised, using a more intense scan-type, with the goal of rapidly identifying adversary activity or malicious logic, not to perform a complete forensic examination. The scan may search for further indicia of malicious activity as set forth in further detail below, including backdoors, tools in volatile or non-volatile memory used for exfiltration, expansion of access or attack, rogue administrator accounts or malicious/unauthorized use of elevated credentials, or live network connections to suspicious sources.

Each of the plurality of payloads 203 may direct the at least one host 201 perform one or more of the operations described in further detail below for the execution of a payload 203. The computing device 202 may deploy multiple payloads simultaneously in one host 201. For instance, multiple payloads 203 may perform differing scans on the same computing devices within the at least one host 201. In other embodiments, some payloads 203 are installed on different computing devices in the at least one host 201 from other payloads. The at least one payloads 203 may follow a progression, wherein one category of payload 203 runs on one computing device before a second category can run on the same device; likewise, a payload 203 that is especially invasive may be executed on a rolling basis on only a fraction of the computing devices making up the at least one host 201 at one time, to avoid creating outages or impacting the productivity of the at least one host 201 as a whole.

In some embodiments, where the computing device 202 connected to the at least one host 201, the computing device 202 disconnects from the at least one host 201. The computing device 202 may proceed to a second host 201 and deploy a payload to that host 201. In some embodiments, the computing device 202 connects to a plurality of hosts 201 simultaneously via parallel computing, such as multithreading; the computing device 202 may disconnect from each host 201 after deploying the at least one payload 203 to save execution time, so that the computing device may deploy additional payloads 203 to additional hosts 201 in a more timely manner. A first thread executing on the computing device 202 may deploy a first payload 203 to the at least one host 201, and disconnect, while a second thread may later deploy a second payload 203 to the at least one host 201 and disconnect in turn. In some embodiments, the computing device remains connected to the at least one host 201 during the execution of the at least one payload.

The at least one host 201 executes the at least one payload 203 (303); the at least one host 201 may execute the at least one payload 203 while disconnected from the computing device. The at least one host 201 may execute the at least one payload 203 while connected to the computing device. In some embodiments, the at least one payload 203 directs the at least one host 201 to collect at least one signature. In other embodiments, the at least one payload 203 directs the at least one host 201 to collect at least one potential malware file. The potential malware file may be an entire file located on the at least one host 201. The potential malware file may be a portion of a file located on the at least one host 201; for instance, a few lines of suspicious code may be embedded in what appears to be an otherwise legitimate file, and the at least one payload 203 may direct the at least one host 201 to collect either the few lines of suspicious code or the entire file. The potential malware file may be a file that apparently performs algorithms that could either be malicious or legitimate; for instance, the file may conceal processes from the at least one host 201, which may indicate that the file is part of a rootkit, or that the file is part of a protocol whereby processes are legitimately hidden for reasons of security or efficiency. The potential malware file may be subjected to sandbox testing as disclosed in further detail below. Many techniques used to hide malware and rootkits are also used by legitimate software, especially other security software and occasionally software with strict Digital Rights Management functions. The availability of sandbox testing and general or custom whitelists, as described below, enables the scanning process to enumerate all such activity so that the computing device 202 or an operator thereof may directly clear the function and legitimacy of software with functionality shared by malware.

In some embodiments, the at least one payload 203 directs the at least one host 201 to collect machine analytics. In some embodiments, the at least one payload 203 directs the at least one host 201 to evaluate at least one operating system kernel memory structure of the at least one host for indications of tampering. For instance, the at least one payload 203 may contain instructions to search the kernel memory structure for evidence that there a rootkit has been installed in the at least one host 201. In one embodiment, the at least one payload 203 directs the at least one host 201 to utilize a kernel-mode driver to get under rootkit subversion techniques, as described above in reference to FIG. 2. In some embodiments, the at least one payload 203 directs the at least one host 201 to search for a hook. In other embodiments, the at least one payload 203 directs the at least one host 201 to scan for modifications to kernel protection features. In additional embodiments, the at least one payload 203 directs the at least one host 201 to evaluate an operating system boot-up sequence for signs of redirection of the boot process.

In some embodiments, the at least one payload 203 directs the at least one host 201 to collect a vendor digital certificate of at least one file. In some embodiments, the at least one payload 203 directs the at least one host 201 to scan memory of the at least one host to identify insecure coding practices. For instance, some insecure practices may be associated with potentially unwanted programs and malware, such as malware calculated to subvert security on the at least one host 201, to allow the installation of further malware or to facilitate an intrusion. The scan for insecure coding practice may include validating use of proper memory protections and security features usually present in properly designed programs. In some embodiments, identification of insecure coding practices in a file causes the at least one payload 203 to direct the at least one host 201 to identify that file as a potential malware file as described above in reference to FIG. 3. In some embodiments, the at least one payload 203 directs the at least one host 201 to analyze memory to detect process injections, such as dynamically linked library file injections.

Some embodiments of the at least one payload 203 direct the at least one host 201 to detect evidence of intrusions. In some embodiments, malware is evidence of intrusion; the computing device 202 may analyze the malware to identify a specific form of intrusion, as set forth in further detail below. In other embodiments, the at least one payload 203 directs the at least one host 201 to scan for remote accesses by users having administrative privileges; detection of remote accesses may help determine that a particular user engaged in malicious activity. Detection of remote accesses may help determine that the credentials of a particular user were used in malicious activity. The at least one payload 203 may direct the at least one host 201 to correlate remote accesses by one or more uses having administrative privileges with the introduction of other evidence of malicious activity. The at least one payload 203 may direct the at least one host 201 to identify one or more computing devices from which one or more users having administrative privileges have remotely accessed the at least one host 201. The at least one payload 203 may direct the at least one host 201 to identify one or more geographic locations from which one or more users having administrative privileges have remotely accessed the at least one host 201.

In some embodiments, the at least one payload 203 determines that the at least one host is compromised. In one embodiment, when the at least one payload 203 determines that the at least one host is compromised, the at least one payload 203 locks down the at least one host. For instance, the at least one payload 203 may instruct the at least one host 201 to install and run a “cage” utility, locking down a compromised host. In some embodiments, the computing device 202 is still able to communicate with the at least one host 201 when the cage utility is installed, but communication with any other machine, including other parts of the network in which the at least one host 201 is incorporated, is disabled. In some embodiments, upon determining that the at least one host is compromised, the at least one payload 203 alerts at least one user regarding the determination. The user may be a security analyst. In some embodiments, the at least one payload 203 directs the at least one host 201 to delete a detected threat.

In some embodiments, the at least one payload 203 installs a sniffer on the at least one host. In some embodiments, the sniffer is a lightweight Intrusion Detection utility, such as the SNORT intrusion detection system belonging to Cisco Systems, Inc. of San Jose Calif., that turns any endpoint into a sensor to collect and analyze packets on the endpoint's subnet. The sniffer may be inserted into the at least one host 201 to intercept and analyze messages between endpoints, to detect data consistent with intrusions.

In some embodiments, the at least one payload 203 directs the at least one host 201 to create an output file 204. The output file 204 may contain a report containing anything the at least one payload 203 directed the at least one host to scan for, as described above in reference to FIG. 3. For instance, the output file 204 may contain an identification that the at least one host 201 is compromised. The output file 204 may contain one or more signatures that the at least one host 201 discovered as directed by the at least one payload 203. The output file 204 may contain data describing the one or more signatures. The output file 204 may contain at least one potential malware file. The output file 204 may contain information identifying at least one potential malware file on the at least one host 201. The output file 204 may contain machine analytics. The output file 204 may contain the results of evaluations of kernel memory structures. The output file 204 may contain the results of rootkit detection scans. The output file 204 may contain data describing a hook discovered during the execution of the at least one payload 203. The output file 204 may contain collected evidence of insecure coding practices. The output file 204 may contain evidence of process injection or dynamically linked library file injection. The output file 204 may include evidence of intrusions. In some embodiments, the output file 204 is encrypted. The output file 204 may be encrypted by any cryptographic system as described above in reference to FIG. 2. The at least one payload 203 may direct the at least one host 201 to sign the output file 204 with a digital signature. The output file 204 may be stored in memory of the at least one host 201. The payload 203 may direct the at least one host to delete the payload 203 after the production of the output file 204.

The computing device 202 retrieves the encrypted output file 204 from the at least one host 201 (304). In some embodiments, the at least one payload 203 instructs the at least one host 201 to store the output file 204 in a particular location within the file directory of the at least one host 201; the computing device 202 may maintain the identity of that particular location in memory accessible to the computing device 202. In other embodiments, the computing device 202 searches for the output file 204 within the memory of the at least one host 201. The output file 204 may have a name specified by the at least one payload 203, so that the computing device 202 may identify the output file 204. The computing device 202 may retrieve the output file 204 using any techniques described above in reference to FIG. 3 for the deployment of the at least one payload 203. In some embodiments, the computing device 202 connects to the at least one host 201. The computing device 202 may connect using the same procedure that it used when connecting to the at least one host 201. The computing device 202 may use a different procedure than the one it used when connecting to the at least one host 201. The computing device 201 may receive the output file 204 from a third party system. The computing device 201 may have the output file 204 deployed by a user by means of portable memory or computing devices.

The method 300 includes analyzing, by the computing device, the encrypted output file 204 for evidence of malicious activity (305). The computing device 202 may decrypt the output file 204 using the decryption algorithm corresponding to the cryptographic system used to encrypt the output file 204. In some embodiments, the computing device 202 analyzes the output file 204 for evidence of tampering; for instance, the computing device 202 may verify a digital signature associated with the output file 204, and compare the mathematical representation encoded in the digital signature to the mathematical representation of the output file 204 as recovered by the computing device 202. In other embodiments, the computing device 202 queries a machine analytics database using machine analytics data contained in the encrypted output file 204. For instance, where an administrative user of the at least one host 201 has recently accessed the at least one host 201 from a different computing device than usual, or from a different geographical location than usual, the computing device 202 may determine that the credentials of the user have likely been used by a different person to perform malicious activity. The computing device 202 may query a signature database using signature data contained in the encrypted output file 204. As an example, the output file 204 may contain the signature of a known malware file, and the query may match that signature to a signature stored in the database. The computing device 202 or the at least one host 201 may create a hash from a signature, and the computing device 202 may query the database for a matching hash; the hashing algorithm may be any hashing algorithm, including a cryptographic hashing algorithm. In some embodiments, the computing device 202 assigns a risk score to each component of the at least one host 201 to focus further analysis. In other embodiments, the computing device 202 filters out known good processes and indicators using a software reputation database. The software reputation database may be a database containing metadata of known good software, executables, libraries, and drivers. The database may be hash-based; for instance, the database may be organized by the MD5 or SHA-1 hash. In some embodiments, survey scripts are able to collect attributes or information on what is running on the at least one host 201; this data may then be compared to the software reputation database to identify those processes the scan or analysis can ignore. In some embodiments, the computing device 202 consults a custom whitelist containing a hash, name, and known pathname of each application that is approved and that has been cleared for a particular client, augmenting a software reputation database.

In other embodiments, the computing device uses vendor-agnostic threat intelligence integration to identify perpetrators behind an attack. Threat intelligence integration may involve using a database or feed, known as a threat intelligence source, that describes attributes previously encountered in malware that can be used to detect corresponding attributes in newly encountered malware. The attributes may include signatures of malware. The attributes may include tactics and techniques used by malware. The attributes may include indicators of malware. By comparing the indicators of identified malware or the method of the attack to the threat intelligence source, the system may narrow down who might be behind the attack. Examples of threat intelligence sources include CROWDSTRIKE, produced by Crowdstrike, Inc. of Irvine Calif., TEAM CYMRU, produced by Team Cymru, Inc. of Lake Mary, Fla., and FIREEYE, produced by FireEye, Inc. of Milpitas, Calif.

In some embodiments, the computing device 202 analyzes the output file 204 by performing sandbox testing. In some embodiments, the computing device recovers the potential malware file from the output file 204. In other embodiments, the computing device 202 uses information from the output file 204 identifying a potential malware file to retrieve the potential malware file from the at least one host 201. The computing device 202 may “detonate” a potential malware file, by executing it in a sandbox environment. In some embodiments, the computing device 202 analyzes the results of executing the file; the computing device 202 may scan the sandbox environment according to any method described above for executing the payload 203 as described for step 303 of FIG. 3. In other embodiments, a user interacts with the sandbox environment to determine the effect of the potential malware file; for instance, the user may view the display to see if the potential malware file causes something unusual to display.

In some embodiments, the computing device 202 analyzes the output file 204 by comparing the vendor digital certificate of at least one file with an associated and validly signed digital signature. For example, the computing device 202 may validate a root signing authority represented in the vendor digital certificate of the at output file 204.

In additional embodiments, the computing device 202 analyzes the output file 204 by aggregating test results from multiple hosts to statistically identify deviations from norms; for instance, for a given file type, the computing device 202 may collect information concerning the form and behavior of that file type as it exists in an uncompromised form, to develop a model describing the uncompromised form of that file type. This approach may make it simpler to detect an infection or other malicious change to a file that has not been tested by the computing device 202 when in an uncompromised state; thus, the use of statistical models may allow the computing device 202 to detect a compromised host 201 in the absence of uncompromised “baseline” information concerning that host 201. The information may be collected during the course of other scans performed as described in reference to FIG. 3. The computing device 202 may use the statistically determined norms to avoid false positive identification of malware.

In some embodiments, the computing device 202 analyzes the output file by providing data concerning the output file 204 to a user. Data concerning the output file 204 may include data contained in the output file 204. The computing device may display code to the user. The computing device may display analytics to the user. The computing device may display files to the user. Data concerning the output file 204 may include the results of analysis the computing device performs on the output file 204, as set forth above in reference to step 304 of FIG. 3. The computing device may display analysis results to the user. The computing device may display output of sandbox testing to the user. The user may instruct the computing device 202 to perform additional analysis. The user may instruct the computing device 202 to deploy another payload 203 on the at least one host 201. The user may enter instructions on the computing device 202 for neutralizing a threat. The user may provide the information gained by viewing the data concerning the output file to a proprietor of the at least one host 201, to instruct the proprietor in future security measures; for instance, the user may advise the proprietor to take precautionary measures to prevent future malicious activity. The user may advise the proprietor to deactivate a hardware or software element of the at least one host 201; for instance, a computing device having compromised hardware may need to be deactivated to prevent further harm. The user may inform the proprietor of evidence that a particular user's credentials were used for malicious activity.

In some embodiments, the computing device 202 performs a follow-up scan of the at least one host 201 to verify deletion of the payload 203. The computing device 202 may search the file directory of the at least one host 201 for the payload 203. The computing device 202 may search the file directory of the at least one host 201 for a signature of the payload 203. In some embodiments, if the computing device 202 determines that the at least one host 201 did not delete the payload 203, the computing device 202 deletes the payload 203. In other embodiments, the computing device 202 alerts a user as described above in reference to step 303 of FIG. 3. The computing device 202 may lock down the at least one host 201 as described above in reference to step 303 of FIG. 3. In the event that the computing device 202 or a payload 203 is operating at the same time as an adversary on the at least one host 201, the computing device 202 or an operator of the computing device 202 may kill the session of the adversary. In cases of computer network exploitation, mitigation may be employed after all lateral movement has been identified to ensure a foothold is not left for the adversary to maneuver around ay defensive actions. Network blocks, malware killing, signature deployment, and vulnerability patching may all take place simultaneously in order to halt all available accesses an intruder has obtained.

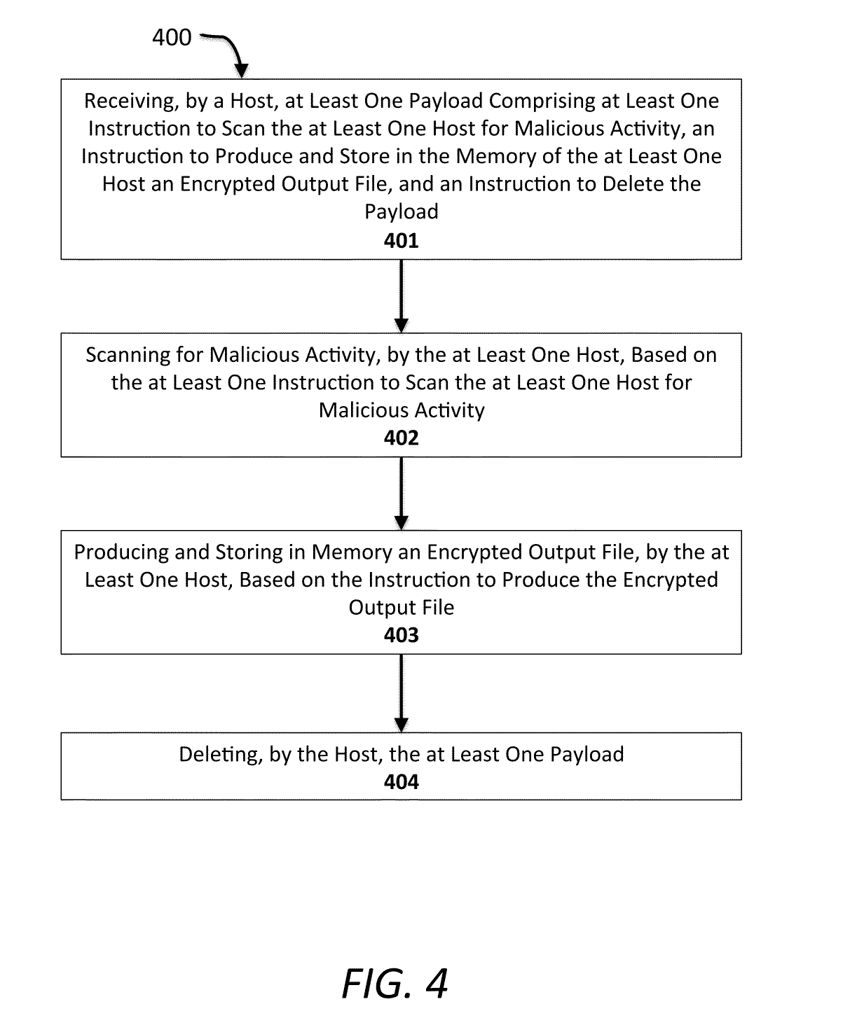

FIG. 4 illustrates some embodiments of a method 400 for scanning hosts using an autonomous, self-destructing payload. The method 400 includes receiving, by a host, at least one payload comprising at least one instruction to scan the host for malicious activity, an instruction to produce and store in the memory of the one host an encrypted output file, and an instruction to delete the payload (401). The method 400 includes scanning for malicious activity, by the host, based on the at least one instruction to scan the host for malicious activity (402). The method 400 includes producing and storing in memory an encrypted output file, by the host, based on the instruction to produce the encrypted output file (403). The method 400 includes deleting, by the host, the at least one payload (404).

Referring to FIG. 4 in greater detail, and by reference to FIG. 2, the method 400 includes receiving, by a host, at least one payload comprising at least one instruction to scan the host for malicious activity, an instruction to produce and store in the memory of the host an encrypted output file, and an instruction to delete the payload (401). In some embodiments, this is implemented as disclosed above in reference to FIG. 3.

The method 400 includes scanning for malicious activity, by the host, based on the at least one instruction to scan the host for malicious activity (402). In some embodiments, this is implemented as disclosed above in reference to FIG. 3.

The method 400 includes producing and storing in memory an encrypted output file, by the host, based on the instruction to produce the encrypted output file (403). In some embodiments, this is implemented as disclosed above in reference to FIG. 3.

The method 400 includes deleting, by the host, the at least one payload (404). In some embodiments, this is implemented as disclosed above in reference to FIG. 3.

It will be understood that the system and method may be embodied in other specific forms without departing from the spirit or central characteristics thereof. The present examples and embodiments, therefore, are to be considered in all respects as illustrative and not restrictive, and the system method is not to be limited to the details given herein.

What is claimed is:

1. A method for scanning hosts using an autonomous, self-destructing payload, the method comprising:
deploying, by a computing device, at least one payload to at least one host, the at least one payload comprising at least one instruction to scan the at least one host for malicious activity, an instruction to produce and store in the memory of the at least one host an encrypted output file, and an instruction to delete the payload;
executing, by the at least one host, the payload, while disconnected from the computing device;
retrieving, by the computing device, from the at least one host, the encrypted output file; and
analyzing, by the computing device, the encrypted output file for evidence of malicious activity.

2. A method according to claim 1, wherein deploying further comprises:
receiving data concerning the at least one host; and
selecting, based on the data, at least one payload from a plurality of payloads.

3. A method according to claim 1, wherein executing further comprises collecting at least one signature.

4. A method according to claim 1, wherein executing further comprises collecting at least one potential malware file.

5. A method according to claim 1, wherein executing further comprises collecting machine analytics.

6. A method according to claim 1, wherein executing further comprises evaluating at least one operating system kernel memory structure of the at least one host for indications of tampering.

7. A method according to claim 6, wherein evaluating further comprises searching for a hook.

8. A method according to claim 6, wherein evaluating further comprises scanning for modifications to kernel protection features.

9. A method according to claim 1, wherein executing further comprises evaluating an operating system boot-up sequence for signs of redirection of the boot process.

10. A method according to claim 1, wherein executing further comprises collection of a vendor digital certificate of at least one file.

11. A method according to claim 1, wherein executing further comprises scanning memory of the at least one host to identify insecure coding practices.

12. A method according to claim 1, wherein executing further comprises scanning for remote accesses by users having administrative privileges.

13. A method according to claim 1, wherein executing further comprises analyzing memory to detect process injections.

14. A method according to claim 1, wherein executing further comprises:
determining that the at least one host is compromised; and
locking down the at least one host.

15. A method according to claim 1, wherein executing further comprises:
determining that the at least one host is compromised; and
alerting at least one user regarding the determination.

16. A method according to claim 1, wherein executing further comprises deleting a detected threat.

17. A method according to claim 1, wherein executing further comprises executing a sniffer on the at least one host.

18. A method according to claim 1, wherein analyzing further comprises analyzing the encrypted output file for evidence of tampering.

19. A method according to claim 1, wherein analyzing further comprises querying a machine analytics database using machine analytics data contained in the encrypted output file.

20. A method according to claim 1, wherein analyzing further comprises querying a signature database using signature data contained in the encrypted output file.

21. A method according to claim 1, wherein analyzing further comprises performing sandbox testing of data identified by the encrypted output file.

22. A method according to claim 1, wherein analyzing further comprises comparing the vendor digital certificate of at least one file with an associated and validly signed digital signature.

23. A method according to claim 1, wherein analyzing further comprises aggregation of test results from multiple hosts to statistically identify deviations from norms.

24. A method according to claim 1, wherein analyzing further comprises providing data from the encrypted output file to a user.

25. A method according to claim 1 further comprising scanning the at least one host file to verify deletion of the payload.

26. A method for scanning host machines using an autonomous, self-destructing payload, the method comprising:
receiving, by a host, at least one payload comprising at least one instruction to scan the host for malicious activity, an instruction to produce and store in the memory of the at least one host an encrypted output file, and an instruction to delete the payload;
scanning for malicious activity, by the host, based on the at least one instruction to scan the at least one host for malicious activity;
producing and storing in memory an encrypted output file, by the host, based on the instruction to produce the encrypted output file; and
deleting, by the host, the at least one payload.

27. A system for scanning host machines using an autonomous, self-destructing payload, the system comprising:
at least one host; and
a computing device, configured to:
transmit at least one payload to the at least one host, the at least one payload comprising at least one instruction to scan the at least one host machine for malware, an instruction to produce an encrypted output file, an instruction to store the encrypted output file in the memory of the at least one host machine, and an instruction to delete the payload;
disconnect from the at least one host;
reconnect to the at least one host, to retrieve, by the computing device, from the at least one host, the encrypted output file; and
analyze, by the computing device, the encrypted output file for evidence of malicious activity.
